(19) United States
(12) Patent Application Publication
(10) Pub. No.: US 2026/0341580 A1
(43) Pub. Date: Oct. 29, 2026

(54) MAGNETIC ELEMENT

(71) Applicant: LITE-ON TECHNOLOGY CORPORATION, Taipei (TW)

(72) Inventors: Kai-De CHEN, Taipei (TW); Yu-Hsin WU, Taipei (TW); Yong-Long SYU, Taipei (TW); Yi-Wen CHENG, Taipei (TW); Chen CHEN, Taipei (TW)

(21) Appl. No.: 19/317,203

(22) Filed: Sep. 3, 2025

Related U.S. Application Data
(60) Provisional application No. 63/793,033, filed on Apr. 23, 2025.

(30) Foreign Application Priority Data
Aug. 1, 2025 (TW) 114129379

(51) Int. Cl. H01F 27/28; H01F 27/24

(52) U.S. Cl. CPC H01F 27/2823; H01F 27/24

(57) ABSTRACT

A magnetic element includes a core and a winding. The core has a first outer lateral surface and surrounds a through-portion, and the through-portion has a first inner lateral surface opposite to the first outer lateral surface. The first inner lateral surface turns of the winding passing through the first inner lateral surface are greater than the first outer lateral surface turns passing through the first outer lateral surface.

This application claims the benefit of U.S. provisional application Ser. No. 63/793,033, filed Apr. 23, 2025, the subject matter of which is incorporated herein by reference, and claims the benefit of Taiwan application Serial No. 114129379, filed Aug. 1, 2025, the subject matter of which is incorporated herein by reference.

### BACKGROUND OF THE INVENTION

### Field of the Invention

The invention relates in general to a magnetic element.

### Description of the Related Art

Today, magnetic elements require both the required inductance and uniform flux distribution in the core. A common practice is to wind the wire a full number of turns and then connect to the next layer or the next component. However, the more full turns of inductor winding, the greater the copper loss.

### SUMMARY OF THE INVENTION

According to an embodiment of the present invention, a magnetic element is provided. The magnetic element includes a core and a first winding. The core has a first outer lateral surface and surrounding a through-hole, wherein the through-hole has a first inner lateral surface opposite the first outer lateral surface. A first inner winding number of the first winding passing through the first inner lateral surface is greater than a first outer winding number of the first winding passing through the first outer lateral surface.

According to another embodiment of the present invention, a magnetic element is provided. The magnetic element includes a core and a first winding. The core includes a first lateral post, wherein the first lateral post has a first outer lateral surface and a first inner lateral surface opposite to the first outer lateral surface. A first inner winding number of the first winding passing through the first inner lateral surface is greater than a first outer winding number of the first winding passing through the first outer lateral surface.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1A illustrates a schematic diagram of a magnetic element according to an embodiment of the present invention;

FIG. 1B illustrates a schematic diagram of a top view of the magnetic element in FIG. 1A;

FIG. 1C illustrates a schematic diagram of a core of the magnetic element in FIG. 1A;

FIG. 2A illustrates a schematic diagram of a magnetic element 200 according to another embodiment of the present invention;

FIG. 2B illustrates a schematic diagram of a top view of the magnetic element in FIG. 2A;

FIG. 3A illustrates a schematic diagram of a magnetic element according to another embodiment of the present invention;

FIG. 3B illustrates a schematic diagram of a top view of the magnetic element in FIG. 3A;

FIGS. 4 to 6 illustrate schematic diagrams of a plurality of the cores according to various embodiments of the present invention;

FIG. 7A illustrates a schematic diagram of a magnetic element according to an embodiment of the present invention; and

FIG. 7B illustrates a schematic diagram of a top view of the magnetic element in FIG. 7A.

### DETAILED DESCRIPTION OF THE INVENTION

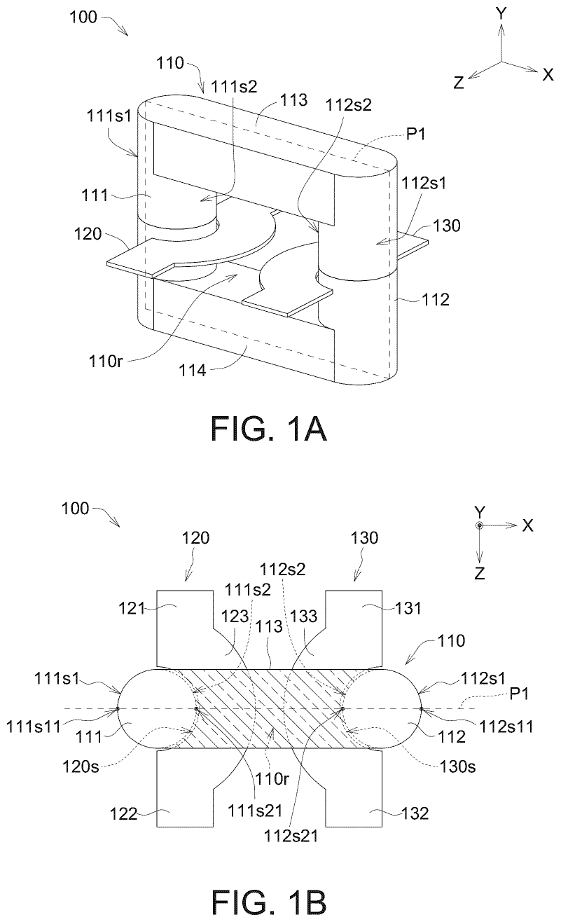

Referring to FIGS. 1A to 1C, FIG. 1A illustrates a schematic diagram of a magnetic element 100 according to an embodiment of the present invention, FIG. 1B illustrates a schematic diagram of a top view of the magnetic element 100 in FIG. 1A, and FIG. 1C illustrates a schematic diagram of a core 110 of the magnetic element 100 in FIG. 1A.

As illustrated in FIGS. 1A to 1C, the magnetic element 100 includes the core 110, a first winding 120 and a second winding 130. The core 110 has a first outer lateral surface 111s1 and surrounds a through-portion 110r (for example, a shaded area in FIG. 1B). The through-portion 110r has a first inner lateral surface 111s2 opposite the first outer lateral surface 111s1. In an embodiment, a first inner winding number (for example, the number of first inner windings) N11 of the first winding 120 passing through (or cross) the first inner lateral surface 111s2 is greater than a first outer winding number (for example, the number of first outer windings) N12 of the first winding 120 passing through the first outer lateral surface 111s1. As a result, it may reduce the DC (Direct Current) resistance (DCR) of the magnetic element 100. According to experimental results, compared to a case where the first outer winding number N12 is greater than the first inner winding number N11, the DC resistance of the magnetic element 100 of the present embodiment may be reduced by at least 60.4% (for example, from 34.13 mΩ to 13.5 mΩ).

Furthermore, the magnetic element 100 of the present embodiment, the DC resistance of the winding may be reduced while a uniform magnetic flux distribution and a desired inductance design may be maintained by leveraging the characteristics of the magnetic core with single magnetic circuit. Such approach may effectively reduce the winding loss of copper wire.

In the present embodiment, the magnetic element 100 includes the first winding 120 and the second winding 130, making it suitable for use as an EMI (Electromagnetic Interference) choke. Depending on the characteristics of the single magnetic core, the magnetic element 100 may employ either flux-coordinating or flux-reversing operation techniques. For example, if the magnetic flux is in the same direction, the first winding 120 may be supplied with a current along the −Z axis, causing the magnetic flux within the core 110 to propagate in the −Z axis (i.e., clockwise). Similarly, the second winding 130 may be supplied with a current along the −Z axis, causing the magnetic flux within the core 110 to propagate in the −Z direction (i.e., clockwise). As a result, the magnetic flux generated by the first winding 120 and the second winding 130 are in the same direction. For example, if the magnetic flux is in opposite directions, the first winding 120 may be supplied with a current along the −Z axis, causing the magnetic flux within the core 110 to propagate in the −Z direction (i.e., clockwise). Meanwhile, the second winding 130 may be supplied with a current along the +Z axis, causing the magnetic flux within the core 110 to propagate in the +Z direction (i.e., counterclockwise). As a result, the magnetic flux generated by the first winding 120 and the second winding 130 are in opposite directions.

In another embodiment, the number of the winding of the magnetic element 100 may have only one. For example, the magnetic element 100 may omit one of the first winding 120 and the second winding 130.

As illustrated in FIGS. 1A to 1C, the core 110 includes a first lateral post 111, a second lateral post 112, a third lateral post 113 and a fourth lateral post 114. The first lateral post 111 and the second lateral post 112 are disposed oppositely, while the third lateral post 113 and the fourth lateral post 114 are disposed oppositely. The third lateral post 113 connects the first lateral post 111 with the second lateral post 112, and the fourth lateral post 114 also connects the first lateral post 111 with the second lateral post 112. The first lateral post 111 has the aforementioned first outer lateral surface 111s1 and first inner lateral surface 111s2. The first lateral post 111, the second lateral post 112, the third lateral post 113 and the fourth lateral post 114 surround the through-portion 110r. In an embodiment, a portion (for example, an upper half) of the first lateral post 111, a portion (for example, an upper half) of the second lateral post 112 and the third lateral post 113 may form an integrally molded structure, and/or the remaining portion (for example, a lower half) of the first lateral post 111, the remaining portion (for example, a lower half) of the second lateral post 112 and the fourth lateral post 114 may form an integrally molded structure, wherein an air gap may be provided between the two integrally molded structures.

In an embodiment, the cross-section of one of the first lateral post 111, the second lateral post 112, the third lateral post 113 and the fourth lateral post 114 is, for example, a circular, polygonal (for example, rectangular, square, etc.), elliptical, or other geometrically shaped. In an embodiment, one of the first lateral post 111, the second lateral post 112, the third lateral post 113 and the fourth lateral post 114 is a cylinder, a polygonal cylinder, an elliptical cylinder or other geometrically shaped cylinder.

In addition, the core 110 may be made of, for example, a ferromagnetic metal (for example, iron) or a ferrimagnetism compound (for example, ferrite).

The windings herein are made of, for example, copper. In addition, the first winding 120 and the second winding 130 may be implemented, for example, as foil wire or Litz wire.

As illustrated in FIGS. 1A and 1B, the first winding 120 may pass through the through-hole 110r. The first winding 120 includes a first portion 121, a second portion 122 and a wrapping portion 123 connecting the first portion 121 with the second portion 122. The wrapping portion 123 is arc-shaped and surrounds the first lateral post 111 of the core 110. The first portion 121 and the second portion 122 extend, for example, from the through-hole 110r and extend linearly in two opposite directions (for example, along the −Z axis and the +Z axis).

As illustrated in FIGS. 1A and 1B, the first inner lateral surface 111s2 is curved-surface, and the first winding 120 has a surface 120s that extends in conformity with the first inner lateral surface 111s2. For example, the wrapping portion 123 has the aforementioned surface 120s which faces the first inner lateral surface 111s2 and extends in conformity with the geometry of the first inner lateral surface 111s2. For example, if the first inner lateral surface 111s2 is curved-surface, the surface 120s may also be a corresponding curved-surface or similar curved-surface.

As illustrated in FIGS. 1A and 1B, if at least a portion of the first winding 120 is adjacent to the first inner lateral surface 111s2 once, the first inner winding number N11 may be counted as one; if at least a portion of the first winding 120 is adjacent to the first inner lateral surface 111s2 twice, the first inner winding number N11 may be counted as two, and so on. For example, the wrapping portion 123 is adjacent to the first inner lateral surface 111s2. In the present embodiment, only one wrapping portion 123 of the first winding 120 is adjacent to the first inner lateral surface 111s2, so the first inner winding number N11 is counted as one.

As illustrated in FIGS. 1A and 1B, if at least a portion of the first winding 120 is adjacent to the first outer lateral surface 111s1 once, the first outer winding number N12 is counted as one; if at least a portion of the first winding 120 is adjacent to the first outer lateral surface 111s1 twice, the first outer winding number N12 is counted as two, and so on. In the present embodiment, no portion of the first winding 120 is adjacent to the first outer lateral surface 111s1, so the first outer winding number N12 is counted as zero.

As illustrated in FIGS. 1A and 1B, the first inner lateral surface 111s2 is, for example, the surface of the peripheral surface of the first lateral post 111 that contacts the through-portion 110r, while the first outer lateral surface 111s1 is, for example, the surface of the peripheral surface of the first lateral post 111 that does not contact the through-portion 110r. The first outer lateral surface 111s1 has a first outer reference line 111s11, and the first inner lateral surface 111s2 has a first inner reference line 111s21. A reference plane P1 (for example, parallel to the XY plane) may pass through the first outer reference line 111s11 and the first inner reference line 111s21. In other words, the first outer reference line 111s11 and the first inner reference line 111s21 of the present embodiment are, for example, coplanar. In an embodiment, the reference plane P1 may pass through the central axes of the first lateral post 111 and the second lateral post 112. However, in other embodiments, the reference plane P1 may pass through the through-portion 110r, the first lateral post 111 and the second lateral post 112, where the line where the reference plane P1 intersects the first lateral post 111 may be defined as the first outer reference line 111s11 and the first inner reference line 111s21.

As illustrated in FIGS. 1A and 1B, if at least a portion of the first winding 120 is adjacent to the first inner reference line 111s21 of the first inner lateral surface 111s2 once, the first inner winding number N11 may be counted as one; if at least a portion of the first winding 120 is adjacent to the first inner reference line 111s21 of the first inner lateral surface 111s2 twice, the first inner winding number N11 may be counted as two; and so on. If at least a portion of the first winding 120 is adjacent to the first outer reference line 111s11 of the first outer lateral surface 111s1 once, the first outer winding number N12 may be counted as one; if at least a portion of the first winding 120 is adjacent to the first outer reference line 111s11 of the first outer lateral surface 111s1 twice, the first outer winding number N12 may be counted as two; and so on.

For example, as illustrated in FIGS. 1A and 1B, only one wraparound portion 123 of the first winding 120 is adjacent to the first inner reference line 111s21, so the first inner winding number N11 is counted as one. No portion of the first winding 120 is adjacent to the first outer reference line 111s11, so the first outer winding number N12 is counted as zero. In other words, in the present embodiment, the first winding 120 passes through the through-portion 110r once, and passes through the rest of the peripheral surface of the first lateral post 111 (for example, all peripheral surfaces of the first lateral post 111 except for the portion corresponding to the through-portion 110r) zero times. In other words, the number of the traces of the first winding 120 passing through the through-portion 110r is greater than the number of the traces of the first winding 120 passing through the rest of the peripheral surface of the first lateral post 111. Furthermore, the number of the traces of the second winding 130 passing through the through-portion 110r is greater than the number of the traces of the second winding 130 passing through the rest (for example, among all the peripheral surfaces of the second lateral post 112, the portion other than the through portion 110r) of the peripheral surface of the second lateral post 112.

In summary, the first inner winding number N11 of the first winding 120 passing through the first inner reference line 111s21 that is greater than the first outer winding number N12 of the first winding 120 passing through the first outer reference line 111s11.

As illustrated in FIGS. 1A and 1B, the second winding 130 may pass through the through-portion 110r. The second winding 130 includes a first portion 131, a second portion 132 and a wrapping portion 133, wherein the wrapping portion 13 connects the first portion 131 with the second portion 132. The wrapping portion 133 is arc-shaped and surrounds the second lateral post 112 of the core 110. The first portion 131 and the second portion 132 extend linearly in opposite directions (for example, along the −Z axis and the +Z axis respectively).

As illustrated in FIGS. 1A and 1B, the core 110 has a second outer lateral surface 112s1, and the through-portion 110r has a second inner lateral surface 112s2 opposite the second outer lateral surface 112s1. In an embodiment, the second inner winding number N21 of the second winding 130 passing through the second inner lateral surface 112s2 is greater than the second outer winding number N22 of the second winding 130 passing through the second outer lateral surface 112s1. As a result, it may reduce the DC resistance of the magnetic element 100. According to experimental results, compared to the second outer winding number N22 being greater than the second inner winding number N21, the DC resistance of the magnetic element 100 may be reduced by at least 60.4% (for example, from 34.13 mΩ to 13.5 mΩ).

As illustrated in FIGS. 1A and 1B, the second inner lateral surface 112s2 is, for example, a portion of the peripheral surface of the second lateral post 112 that contacts the through-portion 110r, while the second outer lateral surface 112s1 is, for example, another portion (or the other) of the second lateral post 112 that does not contact the through-portion 110r.

As illustrated in FIGS. 1A and 1B, the second lateral post 112 has the aforementioned second outer lateral surface 112s1 and the second inner lateral surface 112s2. The second inner lateral surface 112s2 is curved-surface, and the second winding 130 has a surface 130s that extends in conformity with the second inner lateral surface 112s2. For example, the wrapping portion 133 has the aforementioned surface 130s which faces the second inner lateral surface 112s2 and extends in conformity with the geometry of the second inner lateral surface 112s2. For example, if the second inner lateral surface 112s2 is curved-surface, the surface 130s may also be a corresponding curved-surface or similar curved-surface.

As illustrated in FIGS. 1A and 1B, if at least a portion of the second winding 130 is adjacent to the second inner lateral surface 112s2 once, the second inner winding number N21 is counted as one. If at least a portion of the second winding 130 is adjacent to the second inner lateral surface 112s2 twice, the second inner winding number N21 is counted as two, and so on. In the present embodiment, in the second winding 130, only the wrapping portion 133 is adjacent to the second inner lateral surface 112s2, and thus the second inner winding number N21 is counted as one.

As illustrated in FIGS. 1A and 1B, if at least a portion of the second winding 130 is adjacent to the second outer lateral surface 112s1 once, the second outer winding number N22 is counted as one. If at least a portion of the second winding 130 is adjacent to the second outer lateral surface 112s1 twice, the second outer winding number N22 is counted as two, and so on. In the present embodiment, in the second winding 130, no portion is adjacent to the second outer lateral surface 112s1, and thus the second outer winding number N22 is counted as zero.

As illustrated in FIGS. 1A and 1B, the second outer lateral surface 112s1 has a second outer reference line 112s11, and the first inner lateral surface 111s2 has a second inner reference line 112s21. The reference plane P1 passes through the second outer reference line 112s11 and the second inner reference line 112s21. In other words, the second outer reference line 112s11 and the second inner reference line 112s21 are, for example, coplanar.

In an embodiment, the reference plane P1 may pass through the through-portion 110r, the first lateral post 111 and the second lateral post 112, wherein the line where reference plane P1 intersects the second lateral post 112 may be defined as the second outer reference line 112s11 and the second inner reference line 112s21.

As illustrated in FIGS. 1A and 1B, if at least a portion of the second winding 130 is adjacent to the second outer reference line 112s11 of the second outer lateral surface 112s1 once, the second outer winding number N22 may be counted as one. If at least a portion of the second winding 130 is adjacent to the second outer reference line 112s11 of the second outer lateral surface 112s1 twice, the second outer winding number N22 may be counted as two; and so on. If at least a portion of the second winding 130 is adjacent to the second inner reference line 112s21 of the second inner lateral surface 112s2 once, the second inner winding number N21 may be counted as one. If at least a portion of the second winding 130 is adjacent to the second inner reference line 112s21 of the second inner lateral surface 112s2 twice, the second inner winding number N21 may be counted as two; and so on.

For example, only one wrapping portion 133 of the second winding 130 is adjacent to the second inner reference line 112s21, so the second inner winding number N21 is counted as one. In the second winding 130, no portion is adjacent to the second outer reference line 112s11, and thus the second outer winding number N22 is counted as zero.

In summary, the second inner winding number N21 of the second winding 130 passing through the second inner reference line 112s21 is greater than the second outer winding number N22 the second winding 130 passing through the second outer reference line 112s11.

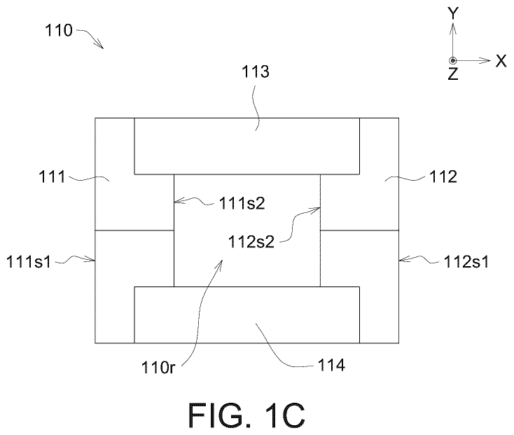

Referring to FIGS. 2A and 2B, FIG. 2A illustrates a schematic diagram of a magnetic element 200 according to another embodiment of the present invention, and FIG. 2B illustrates a schematic diagram of a top view of the magnetic element 200 in FIG. 2A.

As illustrated in FIGS. 2A and 2B, the magnetic element 200 includes the core 110, a first winding 220 and a second winding 230. The core 110 has the first outer lateral surface 111s1 surrounds the through-portion 110r (for example, a shaded area in FIG. 2B). The through-portion 110r has the first inner lateral surface 111s2 opposite the first outer lateral surface 111s1. In an embodiment, the first inner winding number N11 of the first winding 220 passing through the first inner lateral surface 111s2 is greater than the first outer winding number N12 of the first winding 220 passing through the first outer lateral surface 111s1. As a result, it may reduce the DC resistance of the magnetic element 200. According to experimental results, compared to the first outer winding number N12 being greater than the first inner winding number N11, the DC resistance of the magnetic element 200 may be reduced by at least 64.8% (for example, from 34.13 mΩ to 12 mΩ).

The first winding 220 and the second winding 230 may be made of copper, for example. Furthermore, the first winding 220 and the second winding 230 are implemented by, for example, using flat wire or Lizzie wire.

As illustrated in FIGS. 2A and 2B, in the present embodiment, the first winding 220 may pass through the through-portion 110r and linearly (for example, along the Z-axis) pass through the first inner lateral surface 111s2. For example, the first winding 220 linearly (for example, along the Z-axis) passes through the first inner reference line 111s21 of the first inner lateral surface 111s2.

In addition, the calculation method for the first inner winding number N11 of the first winding 220 passing through the first inner lateral surface 111s2 is the same as the calculation method for the first inner winding number N11 of the first winding 220 passing through the first inner lateral surface 111s2, as described above, the calculation method for the first outer winding number N12 of the first winding 220 passing through the first outer lateral surface 111s1 is the same as the calculation method for the first outer winding number N12 of the first winding 120 passing through the first outer lateral surface 111s1, as described above, and they will not be repeated here.

As illustrated in FIGS. 2A and 2B, the second inner winding number N21 of the second winding 230 passing through the second inner lateral surface 112s2 is greater than the second outer winding number N22 of the second winding 230 passing through the second outer lateral surface 112s1. As a result, it may reduce the DC resistance of the magnetic element 200. According to experimental results, compared to the second outer winding number being greater than the second inner winding number N21, the DC resistance of the magnetic element 200 may be reduced by at least 64.8% (for example, from 34.13 mΩ to 12 mΩ).

As illustrated in FIGS. 2A and 2B, the second winding 230 may pass through the through-portion 110r and linearly pass through the second inner lateral surface 112s2. For example, the second winding 230 linearly passes through the second inner reference line 112s21 of the second inner lateral surface 112s2. The calculation method for the second inner winding number N21 of the second winding 230 passing through the second inner surface 112s2 is the same as the calculation method for the second inner winding number N21 of the second winding 230 passing through the second inner surface 112s2, as described above, the calculation method for the second outer winding number N22 of the second winding 230 passing through the second outer surface 112s1 is the same as the calculation method for the second outer winding number N22 of the second winding 230 passing through the second outer surface 112s1, as described above, and they will not be repeated here.

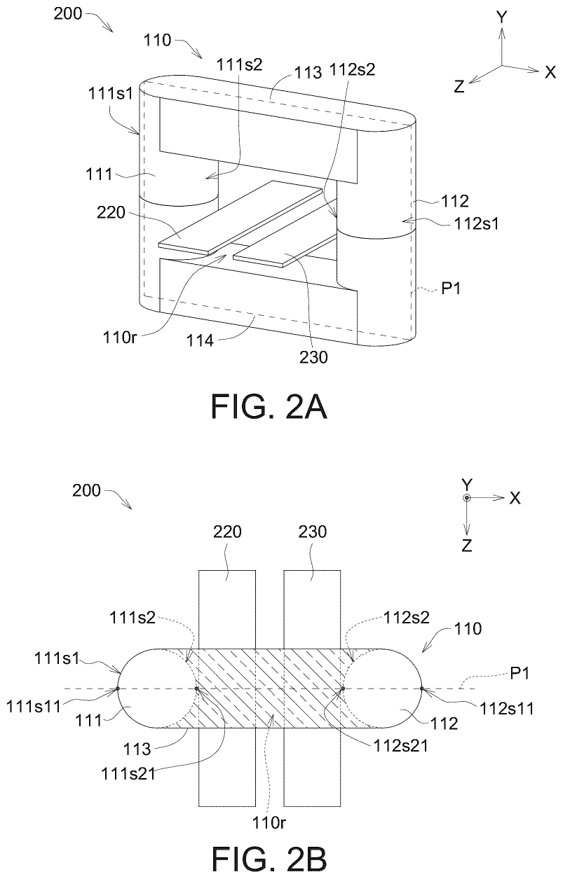

Referring to FIGS. 3A and 3B, FIG. 3A illustrates a schematic diagram of a magnetic element 300 according to another embodiment of the present invention, and FIG. 3B illustrates a schematic diagram of a top view of the magnetic element 300 in FIG. 3A.

As illustrated in FIGS. 3A and 3B, the magnetic element 300 includes the core 110, a first winding 320 and a second winding 330. The core 110 has a first outer lateral surface 111s1 surrounding the through-portion 110r. The through-portion 110r has the first inner lateral surface 111s2 opposite the first outer lateral surface 111s1. In an embodiment, the first inner winding number N11 of the first winding 320 passing through the first inner lateral surface 111s2 is greater than the first outer winding number N12 of the first winding 320 passing through the first outer lateral surface 111s1. As a result, it may reduce the DC resistance of the magnetic element 300. According to experimental results, compared to the first outer winding number N12 being greater than the first inner winding number N11, the DC resistance of the magnetic element 300 may be reduced by at least 40.1% (for example, from 56.6 mΩ to 33.9 mΩ).

The first winding 320 and the second winding 330 may be made of copper, for example. Furthermore, the first winding 320 and the second winding 330 are implemented by, for example, using flat wire or Litz wire.

As illustrated in FIGS. 3A and 3B, in the present embodiment, the first winding 320 may pass through the through-hole 110r. The first winding 320 includes a first portion 321, a second portion 322, a first wrapping portion 323, a second wrapping portion 324 and a third wrapping portion 325, wherein the first wrapping portion 323 connects the first portion 321 with the third wrapping portion 325, and the second wrapping portion 324 connects the second portion 322 with the third wrapping portion 325. The first wrapping portion 323 and the second wrapping portion 324 surround the first inner lateral surface 111s2, while the third wrapping portion 325 surrounds the first outer lateral surface 111s1. The first portion 321 and the second portion 322 extend outside the through-hole 110r, for example, along a straight line (for example, along the Z-axis).

As illustrated in FIGS. 3A and 3B, two portions of the first winding 320 (i.e., the first wrapping portion 323 and the second wrapping portion 324) pass through the first inner lateral surface 111s2 (for example, its first inner reference line 111s21), and thus the first inner winding number N11 is counted as two, while one portion (for example, the third wrapping portion 325) in the first winding 320 passes through the first outer lateral surface 111s1 (for example, its first outer reference line 111s11), and thus the first outer winding number N12 is counted as one. As a result, the first inner winding number N11 of the first winding 320 passing through the first inner lateral surface 111s2 is greater than the first outer winding number N12 of the first winding 320 passing through the first outer lateral surface 111s1. Furthermore, a plurality of portions of the first winding 320 passing through the first inner lateral surface 111s2 are separated into a plurality of layers, i.e., these portions are staggered. For example, the first wrapping portion 323 and the second wrapping portion 324 of the first winding 320 are separated into two layers along the Y-axis. That is, the first wrapping portion 323 and the second wrapping portion 324 are offset from each other along the Y-axis.

In summary, the first inner winding number N11 of the first winding 320 passing through the first inner reference line 111s21 is greater than the first outer winding number N12 of the first winding 320 passing through the first outer reference line 111s11.

As illustrated in FIGS. 3A and 3B, in the present embodiment, the second winding 330 may pass through the through-portion 110r. The second winding 330 includes a first portion 331, a second portion 332, a first wrapping portion 333, a second wrapping portion 334 and a third wrapping portion 335. The first wrapping portion 333 connects the first portion 331 with the third wrapping portion 335, while the second wrapping portion 334 connects the second portion 332 with the third wrapping portion 335. The first wrapping portion 333 and the second wrapping portion 334 surround the second inner lateral surface 112s2, while the third wrapping portion 335 surrounds the second outer lateral surface 112s1. The first portion 331 and the second portion 332 extend outside the through-portion 110r, for example, along a straight line (for example, along the Z-axis).

As illustrated in FIGS. 3A and 3B, two portions of the second winding 330 (i.e., the first wrapping portion 333 and the second wrapping portion 334) pass through the second inner lateral surface 112s2 (for example, its second inner reference line 112s21), and thus the second winding number N21 is counted as two, while one portion (i.e., the third wrapping portion 335) of the second winding 330 passes through the second outer lateral surface 112s1 (for example, its second outer reference line 112s11), and thus the second outer winding number N22 is counted as one. As a result, the second inner winding number N21 of the second winding 330 passing through the second inner reference line 112s21 is greater than the second outer winding number N22 of the second winding 330 passing through the second outer reference line 112s11. Furthermore, the portions of the first winding 320 passing through the second inner lateral surface 112s2 are separated into a plurality of layers, that is, these portions are staggered. For example, the first wrapping portion 333 and the second wrapping portion 334 of the second winding 330 are separated into two layers along the Y-axis, that is, the first wrapping portion 333 and the second wrapping portion 334 are staggered along the Y-axis.

In summary, the second inner winding number N21 of the second winding 330 passing through the second inner reference line 112s21 is greater than the second outer winding number N22 of the second winding 330 passing through the first outer reference line 111s11.

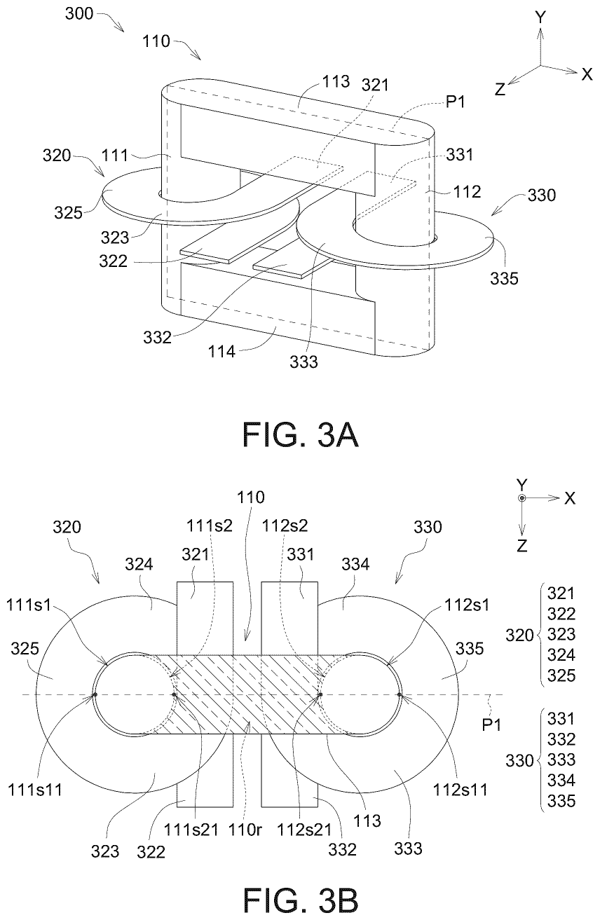

Referring to FIGS. 4 to 6, FIGS. 4 to 6 illustrate schematic diagrams of a plurality of the cores according to various embodiments of the present invention. The core 110 of any of the aforementioned magnetic elements 100 to 300 may be replaced by one of the cores 210 to 410.

As illustrated in FIG. 4, the core 210 is, for example, a ring and includes a first lateral post 211, a second lateral post 212, a third lateral post 213 and a fourth lateral post 214. The first lateral post 211, the second lateral post 212, the third lateral post 213 and the fourth lateral post 214 are equivalent to the first lateral post 111, the second lateral post 112, the third lateral post 113 and the fourth lateral post 114, respectively, and they will not be repeated here. The first lateral post 211, the second lateral post 212, the third lateral post 213 and the fourth lateral post 214 surround a through-portion 210r. In an embodiment, the first winding and the second winding may pass through the through-hole 210r, the geometric relationship between the first winding and the first lateral post 211 is the same as or similar to the geometric relationship between the first winding and the first lateral post 111, and the geometric relationship between the first winding and the second lateral post 212 is the same as or similar to the geometric relationship between the first winding and the second lateral post 112, and they will not be repeated here.

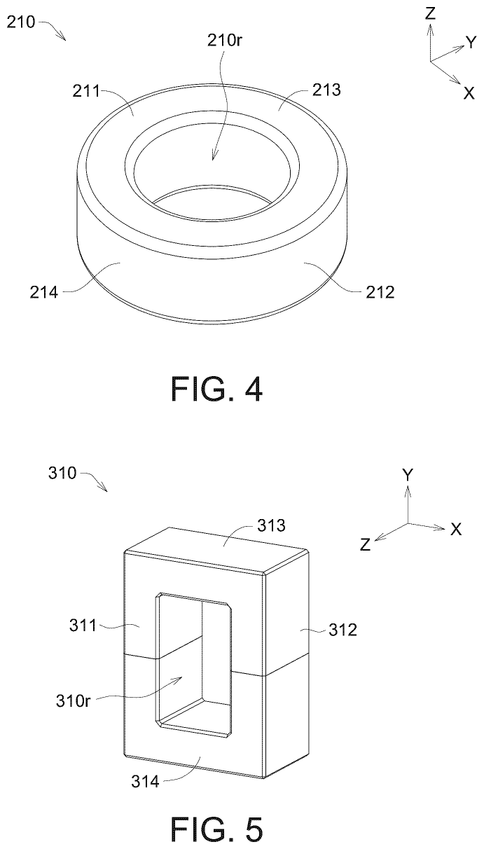

As illustrated in FIG. 5, the core 310 is, for example, a polygonal ring and includes a first lateral post 311, a second lateral post 312, a third lateral post 313 and a fourth lateral post 314. The first lateral post 311, the second lateral post 312, the third lateral post 313 and the fourth lateral post 314 are equivalent to the first lateral post 111, the second lateral post 112, the third lateral post 113 and the fourth lateral post 114, respectively, and they will not be repeated here. The first lateral post 311, the second lateral post 312, the third lateral post 313 and the fourth lateral post 314 surround the through-hole 310r. In an embodiment, the first winding and the second winding may pass through the through-portion 310r, and the geometric relationship between the first winding and the first lateral post 311 is the same as or similar to the geometric relationship between the first winding and the first lateral post 111, and the geometric relationship between the first winding and the second lateral post 312 is the same as or similar to the geometric relationship between the first winding and the second lateral post 112, and they will not be repeated here. In the present embodiment, the cross-section of any one of the first lateral post 311, the second lateral post 312, the third lateral post 313 and the fourth lateral post 314 is, for example, a polygonal shape, such as a rectangle or an oblong. In addition, any one of the first lateral post 311, the second lateral post 312, the third lateral post 313 and the fourth lateral post 314 is, for example, a polygonal column, such as a square column or a rectangular column.

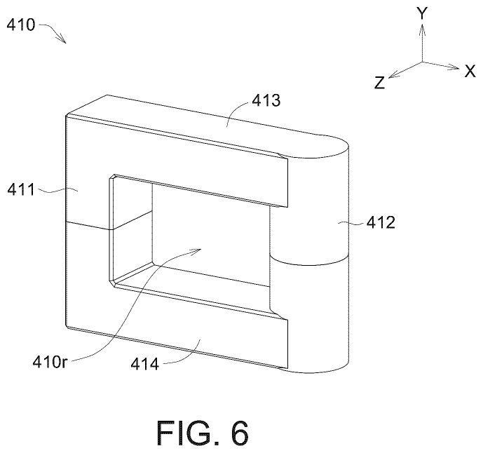

As illustrated in FIG. 6, the core 410 is, for example, a polygonal ring and includes a first lateral post 411, a second lateral post 412, a third lateral post 413 and a fourth lateral post 414. The first lateral post 411, the second lateral post 412, the third lateral post 413 and the fourth lateral post 414 are equivalent to the first lateral post 111, the second lateral post 112, the third lateral post 113 and the fourth lateral post 114, respectively, and they will not be repeated here. The first lateral post 411, the second lateral post 412, the third lateral post 413 and the fourth lateral post 414 surround the through-hole 410r. In an embodiment, the first winding and the second winding may pass through the through-hole 410r. The geometric relationship between the first winding and the first lateral post 411 is the same as or similar to the geometric relationship between the first winding and the first lateral post 111, the geometric relationship between the first winding and the second lateral post 412 is the same as or similar to the geometric relationship between the first winding and the second lateral post 112, and they will not be repeated herein. In the present embodiment, the cross-section of one or more of the first lateral post 411, the second lateral post 412, the third lateral post 413 and the fourth lateral post 414 (for example, the first lateral post 411, the third lateral post 413, and the fourth lateral post 414) is, for example, a polygonal shape, such as a rectangle or an oblong. In addition, the cross-section of another one, others, or the rest of the first lateral post 311, the second lateral post 312, the third lateral post 313 and the fourth lateral post 314 (for example, the second lateral post 412) is, for example, cylindrical shape.

In summary, two of a plurality of the lateral posts of the core may have different cross-sectional shapes, or each of a plurality of the lateral posts of the core may have the same or similar cross-sectional shapes.

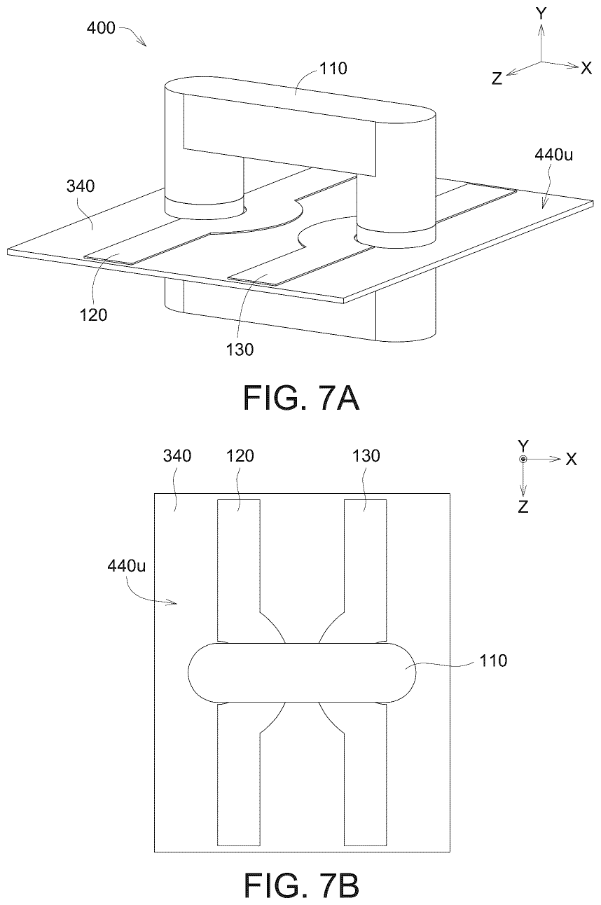

Referring to FIGS. 7A and 7B, FIG. 7A illustrates a schematic diagram of a magnetic element 400 according to an embodiment of the present invention, and FIG. 7B illustrates a schematic diagram of a top view of the magnetic element 400 in FIG. 7A.

As illustrated in FIGS. 7A to 7B, the magnetic element 400 includes the core 110, the first winding 120, the second winding 130 and a circuit board 440. The magnetic element 400 of the present embodiment of the present invention includes the same or similar technical features as the aforementioned magnetic element 100, and at least one difference is that the magnetic element 400 further includes the circuit board 440. The circuit board 440 is, for example, a printed circuit board (PCB) or a flexible printed circuit (FPC).

As illustrated in FIGS. 7A and 7B, the first winding 120 and the second winding 130 are disposed on the circuit board 440. In the present embodiment, the first winding 120 and the second winding 130 may be located on an upper surface 440u of the circuit board 440. In another embodiment, the first winding 120 and the second winding 130 may be embedded within the circuit board 440. In the present embodiment, the first winding 120 and the second winding 130 are, for example, located on one of a plurality of conductive layers (for example, different layers arranged along the Y-axis) of the circuit board 440. In another embodiment, the first winding 120 and the second winding 130 are, for example, located on the same layer of one of the conductive layers of the circuit board 440, or on two different layers of the conductive layers of the circuit board 440.

In another embodiment, the first winding 120 and the second winding 130 of the magnetic element 400 may be replaced by the first winding 220 and the second winding 230.

In other embodiment, the first winding 120 and the second winding 130 of the magnetic element 400 may be replaced by the first winding 320 and the second winding 330. In this example, the first wrapping portion 323 and the second wrapping portion 324 of the first winding 320 may be located on two different layers of a plurality of the conductive layers (for example, different layers arranged along the Y-axis) of the circuit board 440, wherein these two different layers may be electrically connected through at least one conductive via (not shown) of the circuit board 440. Similarly, the first wrapping portion 333 and the second wrapping portion 334 of the second winding 330 may be located on two different layers of a plurality of the conductive layers (for example, different layers arranged along the Y-axis) of the circuit board 440, wherein these two different layers may be electrically connected through at least one conductive via (not shown) in the circuit board 440.

In summary, embodiments of the present invention provide a magnetic element that may be applied to power converters. Specifically, it may be applied to various PFC (power factor correction) circuits, such as Bridge PFC, Semi-Bridgeless PFC, Totem-Pole PFC, and FCML (Flying Capacitor Multilevel) PFC. The magnetic element includes a core and at least one winding. The core has a first outer lateral surface and surrounds a through-portion. The through-portion has a first inner lateral surface opposite to the first outer lateral surface. A first inner winding number of the winding passing through a first inner lateral surface is greater than a first outer winding number of the winding passing through the first outer lateral surface. As a result, the magnetic element may reduce its DC resistance. According to an experimental result, the DC resistance of the magnetic element may be reduced by at least 40%. Specifically, the magnetic element of the present embodiment, by the characteristics of a single magnetic circuit core, reduces the DC resistance of the winding and simultaneously maintains a uniform magnetic flux distribution and the desired inductance design. This approach effectively reduces the winding loss of the copper wire.

While the invention has been described by way of example and in terms of the preferred embodiment (s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A magnetic element, comprising:
a core having a first outer lateral surface and surrounding a through-hole, wherein the through-hole has a first inner lateral surface opposite the first outer lateral surface; and
a first winding, wherein a first inner winding number of the first winding passing through the first inner lateral surface is greater than a first outer winding number of the first winding passing through the first outer lateral surface.

2. The magnetic element as claimed in claim 1, wherein the first outer lateral surface has a first outer reference line, the first inner lateral surface has a first inner reference line, a reference plane passes through the first outer reference line and the first inner reference line, and the first inner winding number of the first winding passing through the first inner reference line is greater than the first outer winding number of the first winding passing through the first outer reference line.

3. The magnetic element as claimed in claim 1, wherein the first outer winding number is zero.

4. The magnetic element as claimed in claim 1, wherein the first inner lateral surface is a curved-surface, and the first winding has a surface that conformity extends along the curved-surface.

5. The magnetic element as claimed in claim 1, wherein the first winding comprises a first portion, a second portion and a wrapping portion connecting the first portion with the second portion; the wrapping portion surrounds a first lateral post of the core, and the first portion and the second portion extend linearly in opposite directions respectively.

6. The magnetic element as claimed in claim 1, wherein the first winding passes linearly through the first inner lateral surface.

7. The magnetic element as claimed in claim 1, wherein the core further comprises a second outer lateral surface, the through-portion further comprises a second inner lateral surface opposite to the second outer lateral surface, the second inner lateral surface faces the first inner lateral surface, and the magnetic element further comprises:
a second winding, wherein a second inner winding number of the second winding passing through a second inner lateral surface is greater than a second outer winding number of the second winding passing through the second outer lateral surface.

8. The magnetic element as claimed in claim 7, wherein the first outer lateral surface has a first outer reference line, the first inner lateral surface has a first inner reference line, the second outer lateral surface has a second outer reference line, and the second inner lateral surface has a second inner reference line; a reference plane passes through the first outer reference line, the first inner reference line, the second outer reference line, and the second inner reference line; and the second inner winding number of the second winding passing through the second inner reference line is greater than the second outer winding number of the second winding passing through the second outer reference line.

9. A magnetic element, comprising:
a core comprising a first lateral post, wherein the first lateral post has a first outer lateral surface and a first inner lateral surface opposite to the first outer lateral surface; and
a first winding, wherein a first inner winding number of the first winding passing through the first inner lateral surface is greater than a first outer winding number of the first winding passing through the first outer lateral surface.

10. The magnetic element as claimed in claim 9, wherein the first outer lateral surface has a first outer reference line, the first inner lateral surface has a first inner reference line, a reference plane passes through the first outer reference line and the first inner reference line, and the first inner winding number of the first winding passing through the first inner reference line is greater than the first outer winding number of the first winding passing through the first outer reference line.

11. The magnetic element as claimed in claim 9, wherein the first outer winding number is 0.

12. The magnetic element as claimed in claim 9, wherein the first inner lateral surface is a curved-surface, and the first winding has a surface that conformity extends along the curved-surface.

13. The magnetic element as claimed in claim 9, wherein the first winding comprises a first portion, a second portion and a wrapping portion connecting the first portion with the second portion; the wrapping portion surrounds a first lateral post of the core, and the first portion and the second portion extend linearly in opposite directions.

14. The magnetic element as claimed in claim 9, wherein the first winding passes linearly through the first inner lateral surface.

15. The magnetic element as claimed in claim 9, wherein the core further comprises a second outer lateral surface, the through-portion further comprises a second inner lateral surface opposite to the second outer lateral surface, the second inner lateral surface faces the first inner lateral surface, and the magnetic element further comprises:
a second winding, wherein a second inner winding number of the second winding passing through a second inner lateral surface is greater than a second outer winding number of the second winding passing through the second outer lateral surface.

16. The magnetic element as claimed in claim 15, wherein the first outer lateral surface has a first outer reference line, the first inner lateral surface has a first inner reference line, the second outer lateral surface has a second outer reference line, and the second inner lateral surface has a second inner reference line; a reference plane passes through the first outer reference line, the first inner reference line, the second outer reference line and the second inner reference line; and the second inner winding number of the second winding passing through the second inner reference line is greater than the second outer winding number of the second winding passing through the second outer reference line.
